(19) United States
(12) Patent Application Publication
(10) Pub. No.: US 2011/0214318 A1
(43) Pub. Date: Sep. 8, 2011

(54) Paper Stock Card with Wireless Communication Capability

(75) Inventor: Gregory A. Dunko, Cary, NC (US)

(73) Assignee: Sony Ericsson Mobile Communications AB, Lund (SE)

(21) Appl. No.: 12/718,270

(22) Filed: Mar. 5, 2010

(51) Int. Cl. G09F 1/00; H04M 3/42

(52) U.S. Cl. 40/124.01; 455/414.1

(57) ABSTRACT

A wireless greeting card or post card includes memory for storing digital content and a wireless transceiver for transferring the digital content to a recipient user device in close proximity to the wireless paper stock card.

### BACKGROUND

The present invention relates generally to paper stock cards and, more particularly, to paper stock cards having memory for storing digital content and a wireless transceiver to transfer digital content from the paper stock card to the recipient user devices.

Paper stock cards, such as greeting cards and post cards, traditionally comprise printed images and text. Some greeting cards may also include an audio synthesizer to reproduce sounds, such as music or a recorded message. Such prior art greeting cards are thus limited in the type of content that the cards can deliver to the recipient Cards with electronic displays for displaying images are also known, but are prohibitively expensive to produce. Accordingly, there is a need for a greeting card that is both inexpensive to produce and capable of delivering any type of digital content to a recipient of the card.

### SUMMARY

The present invention provides a wireless greeting card or post card that is capable of delivering virtually any type of digital content to a recipient of the card. More specifically, a wireless device having memory is incorporated into a card substrate, e.g., a card substrate. The wireless device includes a low power transceiver for communicating with a recipient user device in close proximity to the wireless card. Digital content, such as ringtones or audio files, images, video, and other multimedia, short text messages, and applets, can be stored in memory on the wireless card. When activated, the wireless device on the wireless card may establish a communicating link with the recipient user device and transfer the digital content to the recipient user device. The digital content may include an application program for rendering the digital content by the recipient device. In some embodiments, digital content may be streamed to a nearby device and rendered to the user.

One exemplary embodiment of the wireless card comprises a card substrate; a memory disposed on said card substrate for storing digital content; a wireless transceiver disposed on said card substrate for communicating with a recipient user device; a switch for activating said wireless transceiver and control unit by a recipient of the wireless card; and a control unit operatively connected to the memory, wireless transceiver, and switch. The control unit is configured to establish communication with said recipient user device and to transfer said digital content stored in memory to said recipient user device responsive to activation of said switch by a recipient of said paper stock card.

The control circuit on the wireless card may be configured to detect the presence of the recipient user device and to automatically establish a communication link with the recipient user device.

In some embodiments, the recipient user device may comprise a cellular phone and the control unit may be configured to simulate a base station for communicating with said cellular phone.

In some embodiments, the digital content comprises an electronic card to be rendered by the recipient device. The digital content may further include an application program for rendering the digital content. The application program may be transferred along with the electronic card to the recipient user device.

Another exemplary embodiment of the invention comprises a method implemented by a wireless device disposed on a greeting card, post card, announcement, invitation, or other card for transferring digital content to a nearby user device. The method comprises establishing a communication link between the wireless device on the paper stock card and the recipient user device; and transferring digital content stored in memory on the paper stock card to the user device.

In some embodiments, the method further comprises detecting presence of a recipient user device in proximity to the paper stock card;

In some embodiments, the recipient user device comprises a cellular phone and the method further comprises simulating a base station to transfer content to the cellular phone.

In some embodiments, the digital content comprises an electronic card to be rendered by the recipient user device. The digital content may further comprise an application program for rendering the digital content. The method may include transferring the application program along with the electronic card to the recipient user device.

### BRIEF DESCRIPTION OF THE DRAWINGS

FIG. 1 illustrates a wireless paper stock card according to one exemplary embodiment of the invention.

FIG. 2 illustrates the main functional components of the wireless communication device for a wireless greeting card.

FIG. 3 illustrates an exemplary method of transferring digital content between the memory on the wireless greeting card and a recipient user device.

FIG. 4 illustrates the main functional components of a recipient user device including a greeting card application for communicating with wireless greeting cards.

### DETAILED DESCRIPTION

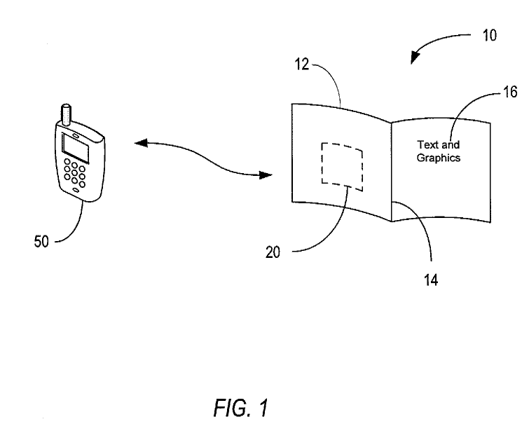

Referring now to the drawings, FIG. 1 illustrates an exemplary greeting card indicated generally by the numeral 10. As used herein, the term greeting card includes any kind expressing friendship or other sentiments including birthday cards, post cards, anniversary cards, invitations, and announcements. The greeting card 10 may be printed on a paper stock substrate or other substrate 12. The substrate 12 may include a fold 14 along the center of the card to allow the card to be folded in half. The card 10 may also include printed matter 16, such as text and graphics, to convey a message to the recipient of the card. The card 10 includes a built-in wireless communication device 20 that is capable of communicating with a user device 50 of the recipient. The recipient user device 50 may comprise, for example, a cellular phone, or personal digital assistant, or other device with wireless communication capability. As will be hereinafter described in greater detail, the card 10 can store digital content that can be transferred to the recipient user device 50. The digital content may, for example, comprise an image, video, a ringtone, a short text message, audio file, or other multimedia content.

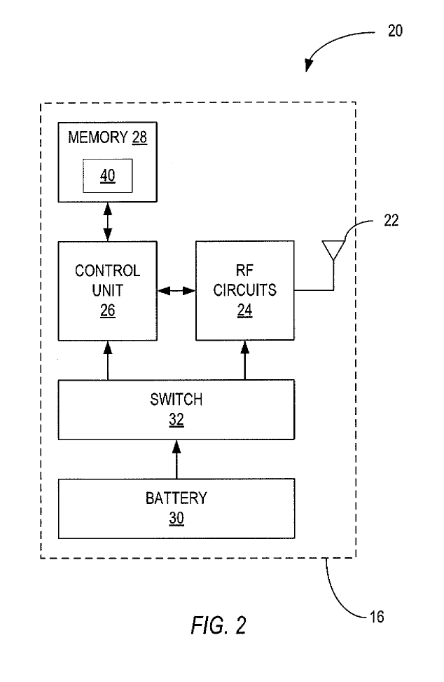

FIG. 2 illustrates the main functional components of the wireless communication device 20 for the card 10. The wireless communication device 20 comprises an antenna 22, RF circuits 24, control unit 26, memory 28, battery 30, and switch 32. The RF circuits 24 may comprise a short-range radio transceiver, such as a Bluetooth transceiver, Zigbee transceiver, or near field communication (NFC) transceiver. In some embodiments, the RF circuits 24 may comprise a low power cellular transceiver operating according to known standards. The control unit 26 processes signals transmitted and received by the RF circuits 24 and controls the overall operation of the wireless communication device 20. The control unit 26 may comprise one or more microprocessors, microcontrollers, hardware, firmware, or a combination thereof. Memory 28 stores digital content 40 to be transferred to a recipient user device 50 as well as program instructions needed for operation. Memory 28 includes non-volatile memory, such as a read-only memory (ROM), erasable programmable read-only memory (EPROM), electrically erasable programmable read-only memory (EEPROM), flash memory, etc. Memory 28 may also include random access memory (RAM) for storing temporary data during operation. Battery 30 provides power to the wireless device 20. Switch 32 connects battery to the other components of the wireless device 20. Switch 32 may, for example, comprise a simple push button switch, or pressure-sensitive switch, that latches once activated.

A highly integrated and greatly simplified wireless communication device 20 can be constructed on a flex circuit 16 or simple circuit board at very low cost and integrated into a paper stock substrate or other substrate 12. The wireless communication device 20 could be very thin and operate at very low power, which would be sufficient to communicate with recipient devices in close proximity. The wireless communication device 20 may be designed for a single use to implement a few simple functions. The wireless communication device 20 could operate on a small watch-like battery with a capacity of 20-50 mAh, which is approximately 5-10% the capacity of a typical mobile phone battery. In one exemplary embodiment, a simplified GSM, GPRS, or WCDMA transceiver operating on a single channel at a single frequency could be used. The wireless communication device 20 could simulate a base station in a mobile communication network to communicate with the user device 50. In other embodiments, the wireless communication device may be capable of peer-to-peer communications with the recipient user device 50.

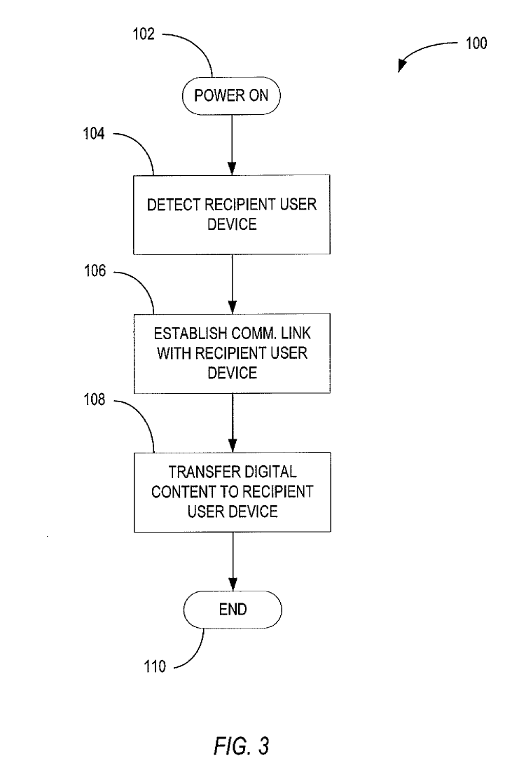

FIG. 3 illustrates an exemplary method 100 according to one embodiment of the invention for transferring digital content from the memory 28 of the wireless card 10 to a recipient user device 50. The method 100 begins when the switch 32 is activated to provide power to the wireless communication device 20 (block 102). Once the wireless communication device 20 is turned on, the wireless communication device 20 implements a discovery protocol to discover nearby devices (block 104). The discovery protocol may be implemented at periodic intervals until a recipient device 50 is detected. The Bluetooth and Zigbee protocols, or example, include discovery procedures for discovering nearby devices.

When a recipient user device 50 is detected, the wireless communication device 20 establishes a communication link with the detected device (block 106). In some embodiments, the user of the recipient user device may be required to accept an invitation to establish a communication link with the wireless communication device 20. In other applications, the recipient user device 50 may include an application program that “recognizes” wireless paper stock cards from a particular manufacturer and automatically establishes a communication link with the wireless paper stock card. A greeting card company may offer the application to users for use with greeting cards from that manufacturer.

Once the communication link is established, the wireless card 10 transfers digital content from memory 28 to the recipient user device 50. In some embodiments, the user may be required to indicate acceptance before the transfer is made. In other embodiments, the digital content may be transferred without further user input from the user. The digital content may, as noted above, comprise ring tones or other audio files, image files, a short text message, applets, or other multimedia content.

In some embodiments, the user application in the recipient user device 50 may render the multimedia content to the user. For example, the digital content may comprise an electronic greeting card that is played to the user after it is downloaded from the wireless paper stock card 10. The wireless card 10 may, in some embodiments, store the user application for rendering the digital content to the user, which is transferred along with the digital content to be rendered. In other embodiments, the media content may be added to the user's library of media content. For example, if the multimedia content comprises a ring tone, the new ring tone may be stored in a folder with other ring tones and added to a list of ring tones available to the user. If the media content is an image, the media content may be added to a folder of other images.

Another aspect of the invention comprises a greeting card application that can be stored in the memory of the recipient user device 50 that is specially adapted for communicating with wireless greeting cards from one or more manufacturers. The recipient wireless device 50 may comprise a cellular phone, personal digital assistant, laptop computer, or other device with wireless communication capability.

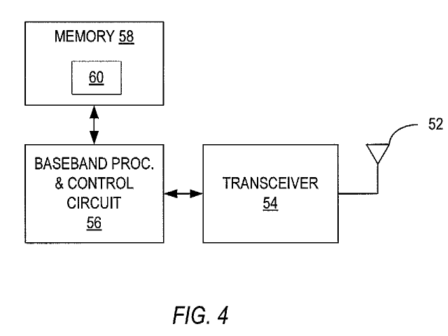

FIG. 4 illustrates an exemplary recipient user device 50 according to one embodiment. The recipient user device comprises one or more antennas 52, a radio transceiver 54, and baseband processing and control circuit 56, and memory 58. The transceiver 54 may comprise a short-range radio transceiver, such as a Bluetooth transceiver, Zigbee transceiver, or near field communication (NFC) transceiver. In some embodiments, the transceiver 54 may comprise a cellular transceiver operating according to known standards. The baseband processing and control circuit 56 processes signals transmitted and received by the transceiver 54 and controls the overall operation of the recipient user device 50. The baseband processing and control circuit 56 may comprise one or more microprocessors, microcontrollers, hardware, firmware, or a combination thereof. Memory 58 stores a greeting card application 60 for communicating with wireless greeting cards 10. Memory 58 includes non-volatile memory, such as a read-only memory (ROM), erasable programmable read-only memory (EPROM), electrically erasable programmable read-only memory (EEPROM), flash memory, etc. Memory 58 may also include random access memory (RAM) for storing temporary data during operation. The greeting card application 60 includes program code for communicating with wireless greeting cards 10 and downloading content from wireless greeting cards 10. The greeting card application 60 may also include program code for organizing and rendering digital content received from wireless greeting cards 10. In some embodiments, the greeting card application 60 may further include program code for generating digital content to be uploaded to a wireless card 10 to be sent to a third party.

The present invention is suitable for use in virtually any kind of greeting card, including post cards, invitation, announcements, or other cards that are typically printed on paper stock.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A greeting card comprising:
a card substrate;
memory disposed on said card substrate for storing digital content;
a wireless transceiver disposed on said card substrate for communicating with a recipient user device;
a switch for activating said wireless transceiver and control unit by a recipient of the card; and
a control unit operatively connected to the memory, wireless transceiver, and switch, said control unit configured to establish communication with said recipient user device and to transfer said digital content stored in memory to said recipient user device responsive to activation of said switch by a recipient of said card.

2. The greeting card of claim 1 wherein the control unit is further configured to detect said recipient user device.

3. The greeting card of claim 1 wherein the recipient user device comprises a cellular phone and wherein said control unit is configured to simulate a base station for communicating with said cellular phone.

4. The greeting card of claim 1 wherein said digital content comprises an electronic card to be rendered by the recipient device.

5. The greeting card of claim 4 wherein the digital content further comprises an application program for rendering the digital content, and wherein the application program is transferred along with the electronic card to the recipient user device.

6. A method implemented by a wireless device disposed on a greeting card sent from a sender to a recipient, said method comprising:
establishing a communication link between the wireless device on the greeting card and a recipient user device; and
transferring digital content stored in memory on the greeting card to the user device.

7. The method of claim 6 further comprising detecting presence of a recipient user device in proximity to the card;

8. The method of claim 6 wherein the recipient user device comprises a cellular phone and wherein said wireless device simulates a base station to transfer the digital content to the recipient user device.

9. The method of claim 6 wherein the digital content comprises an electronic card to be rendered by the recipient user device.

10. The method of claim 8 wherein the digital content further comprises an application program for rendering the digital content, and wherein the application program is transferred along with the electronic card to the recipient user device.

11. A wireless communication device comprising:
a transceiver;
a baseband processing and control circuit for processing signals transmitted and received by said transceiver; and
a memory storing a greeting card application including program code for:
communicating with a wireless greeting card; and
downloading content from said wireless greeting card.

12. The wireless communication device of claim 11 wherein said greeting card application further comprises program code for rendering content downloaded from said wireless greeting card.
